(19) United States
(12) Patent Application Publication
(10) Pub. No.: US 2002/0086262 A1
(43) Pub. Date: Jul. 4, 2002

(54) Parabolic light source with incorporated photographic device

(76) Inventor: J. Tim Rainey, Refugio, TX (US)

Correspondence Address: KILPATRICK STOCKTON LLP, 607 14th STREET, NW, SUITE 900, WASHINGTON, DC, 20005, US

(21) Appl. No.: 09/682,045

(22) Filed: Jul. 13, 2001

Related U.S. Application Data
(60) Provisional application No. 60/218,269, filed on Jul. 13, 2000.

(51) Int. Cl. A61C 1/00

(52) U.S. Cl. 433/29; 600/245

(57) ABSTRACT

A photographic apparatus having a light source adapted to direct light toward a patient for facilitating a care giver's performance of typically a medical or dental procedure upon the patient. A camera lens is located adjacent to the light source and configured so that a photographic view from the camera is similarly directed as the light from the light source for viewing and/or recording the performance of the care giver's procedure upon the patient. Alternatively, the camera lens may be coupled to or mounted directly to the light source to achieve the common direction toward the patient.

### CROSS REFERENCE TO RELATED APPLICATIONS

This patent application claims priority to Provisional Patent Application No. 60/218,269 filed on Jul. 13, 2001.

### BACKGROUND OF INVENTION

It is well known within the dental and other medical fields to use variably positionable parabolic lamps=during examinations and procedure. Such lamps are utilized in examination rooms and surgical operatories, and are especially familiar to dental patients because of such lamp=s use in dental offices. Typically, a lamp is suspended overhead above the patient and an examining professional such as a dentist at a location slightly in front of the patient, but directed toward the patient=s head, and specifically the patient=s oral region. During examinations and dental procedures, the health care provider appropriately positions the lamp to best illuminate either the entire mouth cavity or the specific portion upon which work is being performed. In practice, the lamp will be generally just above and behind the dentist=s head with the projected light beam having a path almost coincident with dentist=s line of sight. As a result, it is not uncommon for the light beam to also strike the side of the dentist=s head. If optical enhancements such as eye glasses or magnification loops are being worn, reflected light can detrimentally affect the dentist=s ability to see.

The conventional construction of the parabolic dental light is such that an incandescent light source is positioned so that it shines upon a parabolic reflector directable toward the patient, and more specifically upon that area of the patient to be examined. The incandescent light source is mounted upon a support member generally positioned in the middle of the parabolic reflector. Through such construction, the support member prevents reflected light thereacross and resultantly establishes a dead or dark space with respect to reflected light at the center of the parabolic lamp. Because of the parabolic configuration of the reflector, however, the reflected light is directed in such a manner that the resulting point of light application receives continuous illumination across the area of interest.

In another aspect of the medical professional=s practice, patient conditions and procedures must be recorded for both charting purposes, as well as third party communications such as to insurers of patients for payment reimbursements. For this reason, it has been recognized as desirable by the medical profession, and specifically dental professionals to have ways to visually record patient conditions and performed procedures. In some instances, the patient himself or herself may request to visualize the condition asserted to require treatment by the dentist or other health care provider. Similarly, an insurance company may require a photograph of the deteriorating tooth structure or other deficiency for insurance coverage purposes.

### SUMMARY OF INVENTION

In response to these requirements and desires, hand held cameras have been developed which may be positioned within the oral cavity and directed upon a particular tooth or area of interest. What has been discovered, however, is that during the use of such hand held devices which are positioned within the patient=s mouth, exhalation can cause fogging of the camera lense and prevent effective photography. Also, because the dentist must hold the wand upon which the camera is located and position it within the patient=s mouth, the camera is subject to movement, even if only quivering by either the patient or the dentist which hampers effective photography of the area of interest. Still further, such a hand held camera may be used to view the tooth structure before a procedure is performed and subsequently after the procedure is performed, but it is difficult, if not impossible to position such a camera for continuous viewing during the procedure=s performance.

In response to these needs and the deficiencies of the available photographic means to such health care professionals, and particularly dentists, the present invention has been developed. The invention incorporates into a conventional parabolic dental lamp a digital camera also referred to as a computerized camera device aimable at the same area of interest upon the patient that the reflected light beam is aimable upon. Advantageously, the support member for the incandescent lamp source is utilizable for mounting the camera=s lens portion within the dark or dead space of the lamp=s parabolic reflector. Such cameras are well known in the photographic arts and their implementation may be easily accomplished by those skilled in the art and familiar with their operation and mounting requirements. Through the camera=s capabilities for zooming, magnification and other enhancements to the viewed area, the computerized camera device provides many benefits to both the patient and health care provider. Among others, by removing the camera and its lens portion from having to be positioned within the patient=s mouth, the health care provider=s ability to manipulate within and about the mouth cavity is not inhibited. Because the light is variably positionable, so is the camera mounted thereon. As a result, if the patient is re-positioned for either better access by the dentist or to maintain comfort, the light and accompanying camera can be similarly repositioned to an appropriate orientation.

The image viewed by the camera is then communicated to a display screen where it is viewable by at least the care provider, and may be positioned for simultaneous or separate viewing by the patient. As a complement, during this communication process or as another receiver, the images may be recorded either as motion video or still photographs. Each type of recording may be easily accomplished by the camera=s digital capabilities through which the images may be captured in electronic form for later manipulation, visualization, and printing.

As a result of the present invention wherein a camera is positioned within a parabolic medical lamp, the care provider and patient both benefit from the ability to visualize conditions and medical procedures, but also by its facilitation of communication of those conditions and procedures to third parties. In these litigious times, the video recording of medical procedures performed may be archived in the event that a legal question arises in connection therewith in the future. It is for these and other reasons that will be readily recognized by both those skilled in the art associated with this invention, and the public that takes advantage of the services of health care providers that the invention as described has been developed.

While a preferred position for the camera's lens has been described as being located at a substantial center of the light assembly, it should be appreciated that the lens may be alternatively mounted at various locations about the light, while continuing to affect the advantages described herein.

### BRIEF DESCRIPTION OF DRAWINGS

In the following, the invention will be described in greater detail by way of examples and with reference to the attached drawings, in which:

FIG. 1 is a perspective view of a dental chair with a parabolic dental lamp associated therewith that has a camera incorporated therein according to the present invention.

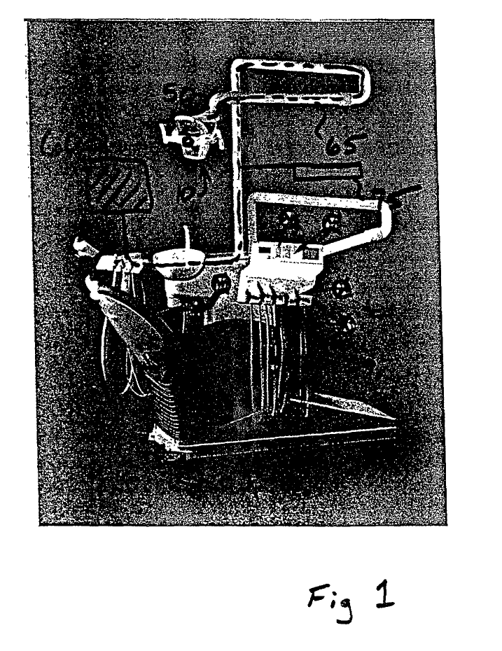

FIG. 2 is a perspective view looking toward the reflective parabolic surface of the dental lamp.

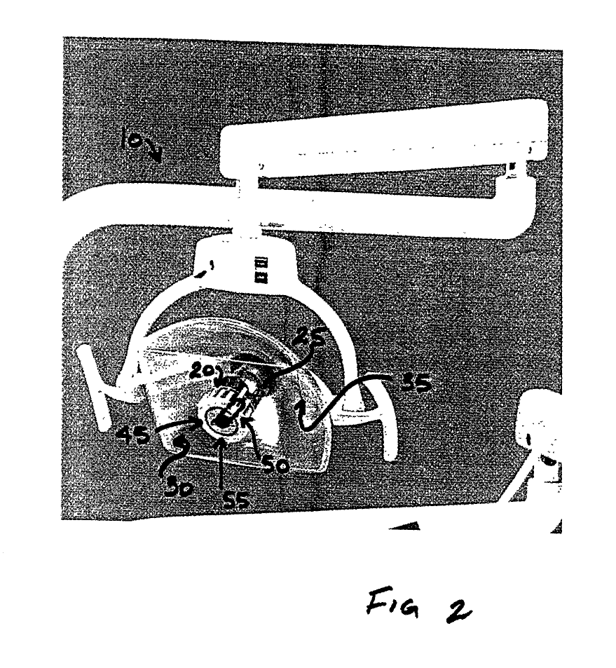

### DETAILED DESCRIPTION

As required, detailed embodiments of the present invention are disclosed herein;

however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

The present invention contemplates the entire assembly required for perceiving either a patient or a specific area upon a patient visually through a camera 50 and transmitting the image perceived through a communicator 65 to a display screen 60 where what has been visualized by the camera 50 is converted into a displayable image upon the screen 60 that can be observed by the patient and the care provider, as well as others. The assembly further includes devices capable of recording those images both as motion video and as instantaneous still photographs. The devices by which these recordings may be made include computers and other devices utilizing magnetic media and digital means for the recordings, as well as analog recorders such as VHS and other well known recording devices. Such procedures and the assemblies utilized may be likened to security systems where security camera recordings are made of specific areas within a residence or commercial building. It is expected that the recording media may optionally be easily disengaged from the recording device and archived for later reference, if required. Examples would be computer floppy disks upon which the recordings may be saved or magnetic video tapes comparable to those used in commercially available video cassette recorders (VCRs).

As described hereinabove, variably positionable lamps 10 are well known in the medical fields, and are particularly familiar because of their utilization in dental offices. The lamps 10 are typically suspended overhead above and in front of the patient. In this manner, the illumination provided by the lamp 10 may be adjusted to be aimed at a particular area of interest. In the instance of dental procedures, this area of interest will normally be the patient=s mouth cavity which corresponds to a viewable area 15 of interest to the care provider. The lamp 10 includes an incandescent light source 25 that is positioned in front of a parabolic reflector 30 so that the light source 25 is located between the reflector and the patient. Typically, the light source is mounted upon a mid-positioned support member 20 relative to the reflector 30. The reflector 30 is advantageously parabolically shaped so that the reflected light rays are bent around a dark or light dead center space 45 of the lamp 10. This dead space 45 corresponds to the back side of the support member 20 facing directly toward the patient. By bending and focusing light rays around the dark center space 45, a projected light beam 70 is produced that may be specifically directed upon the area of interest 15 of the patient. Previously, the care provider, and most typically a dentist, positioned the lamp 10 slightly behind, but adjacent to his or her head and directed the light beam 70 toward the patient=s mouth area 15. In this manner, the light beam 70 was most nearly aligned with the doctor=s line of sight. Because both the projected light beam 70 and the doctor=s line of sight are linear, near coincidence was highly advantageous. As described above, however, this coincidence can be detrimental to the doctor=s visibility. Not only will portions of the light 70 shine on the dentist, but portions of the light beam 70 may shine on the back side of eyeglasses or other apparatus that resultingly impairs the doctor=s sight. As an option to conventional dental lamps 10, a light diffuser 35 may be added upon the lamp=s 10 structure for dampening the harshness of the light in the patient=s eyes. The diffuser 35, however, diminishes the capability for focusing the projected light beam 70 and may enhance the likelihood that peripheral light beam portions will strike the care provider and the back side of optical enhancement devices such as glasses.

The present invention takes advantage of the dark, dead center space 45 of the lamp 10 and positions the camera device 50 therein. Exemplary camera devices 50 are well known in the photographic arts and optimally are of a digital nature capable of providing high resolution displays of perceived images. In an exemplary embodiment, the camera 50 is a computerized camera device having a one-half inch head 55 with a lens directed toward the area of interest 15 and in-line with the projected light beam 70 generated by the lamp 10. Advantageously, the head 55 of the camera 50 is mounted upon the support member 20 opposite to the incandescent light source 25. The camera 50, its head 55 and related assembly may be inclusively positioned upon the support member 20, or portions may be remotely located for example behind the parabolic reflector 30 or even more remote, if required. A communicator 65 is used for transmitting the perceived images to the display screen 60 where they may be visualized by the care provider and/or patient. The communicator 65 may be of variable construction and may include hard-wired connections between the camera 50 and display screen 60. Alternatively, the communicator is not a physical connection and the information is transferred as radio waves or infra-red waves similar to those used in remote control technology. Any suitable means for transmitting the images perceived by the camera 50 to the display screen 60 where they are reproduced for viewing may be utilized. At any stage of this assembly between the camera 50 and the screen 60, or even after the display screen 60, a recorder 75 is located in the communication path capable of making motion video recordings of the images and/or instantaneous still photographs of any image transferred from the camera 50.

The capability of commercially available digital cameras 50 are wide range. The cameras 50 utilized in the present invention provide capabilities for magnification of, and zooming into specific areas where greater detail is required. Through present technology, such cameras 50 may even be utilized to magnify images to such a degree that bacteria may be visualized and its effect appreciated, particularly in oral settings. As such, the present invention can replace the global microscopes presently utilized in dental settings at a significant cost savings.

In use, the camera 50 and displayed image will free the dentist from being required to align his sight with that of the projected light beam 70. Through the use of the present invention, the care provider may have a real time visual representation upon the display screen 60 of his movements during a procedure within the patient=s mouth cavity. This not only frees the dentist to move about more freely and enhance dexterity in the performance of required procedures, but it also permits the light to be directed from positions other than adjacent to the dentist=s head.

The patient and care provider will find great benefit from being able to each visualize conditions requiring medical attention. This capability will provide great comfort to the patient who has previously been required to rely solely upon the representation of the care provider. Still further, because of the recording capabilities, still images and motion videos of procedures and operations performed upon a patient may be saved for third party viewing.

1. A photographic apparatus comprising:
a light source adapted to direct light toward a patient for facilitating a care giver's procedure upon the patient; and
a camera lens located adjacent to said light source, a photographic view from said camera being similarly directed as the light from said light source for viewing and/or recording the performance of the care giver's procedure upon said patient.

2. The photographic apparatus as recited in claim 1, further comprising:
said camera lens being coupled to said light source for common direction toward said patient.

3. The photographic apparatus as recited in claim 1, further comprising:
said camera lens being mounted upon said light source for common direction toward said patient.
